(19) United States
(12) Patent Application Publication
(10) Pub. No.: US 2009/0272497 A1
(43) Pub. Date: Nov. 5, 2009

(54) Taping Apparatus

(76) Inventor: Christopher Pyles Pyles, San Diego, CA (US)

Correspondence Address: Christopher Pyles, 11767 Westview Pkwy., San Diego, CA, 92126, US

(21) Appl. No.: 12/114,834

(22) Filed: May 5, 2008

(51) Int. Cl. B32B 37/00; B32B 38/00

(52) U.S. Cl. 156/523

(57) ABSTRACT

A tape applicator device that applies tape to a surface edge that is contiguous with a second surface and can also cut the tape to fit precisely up to a third surface that orthogonally intersects the first and second surfaces forming an inside corner like that found at the juncture of two walls and a ceiling. The applicator employs an upper and lower cutting blade and a tape measuring element to precisely measure and cut the tape to the desired length to fit into an inside corner. The tape applicator of the invention also includes a tape roll journaling means and tape guide means to dispense and apply tape to the surface edge.

### BACKGROUND

1. Field of the Invention

The present invention relates generally to the field of painting and more particularly, it relates to a taping apparatus having a cylindrical hub for mounting a roll of tape, a secondary arcuate surface for pressing tape down to a surface, and a tape measuring and cutting mechanism, which allows a user to precisely cut the tape to the desired length without requiring the use of additional tools such as a blade or scissors.

2. Description of the Prior Art

A major problem that is encountered when taping the edges of a wall is the difficulty in taping up to the edge quickly and accurately. It is common practice to accomplish this unaided by holding the roll of tape in one's hand while pulling out tape, lining it up to the edge and pressing it down to the surface. This process is time-consuming and difficult to do accurately. Adding to the difficulty, when taping up to an inside corner, a user has to use another tool to cut the tape to fit into the corner. This cutting process can be particularly time-consuming when taping surfaces that have multiple inside corners like those found around mullions in windows or French doors.

A number of prior devices have been developed in an effort to aid in placing the tape up to an edge, but they do not allow a user to tape precisely up to an inside corner. Furthermore, prior devices require the use of two hands to cut the tape, whereby one hand is used to hold the tape on the surface and the other hand engages a serrated blade to tear/cut the tape, which leaves a serrated edge on the tape end.

### SUMMARY

A primary object and/or advantage of the present invention is to combine the speed and precision of a tape applicator with a tape cutting mechanism that accurately measures and cuts the tape to fit into inside corners. This tape cutting mechanism allows a user to take advantage of the efficiency of a tape applicator to apply tape quickly and accurately up to the edge of a surface and the ability to cut the tape off to the correct length without requiring the use of additional measuring or cutting tools.

A more specific object and/or advantage of the present invention is to provide a taping applicator cutting mechanism that will cut the tape to a desired length and substantially orthogonal to fit into an inside corner.

Another object and/or advantage of the present invention is to make the applying and cutting of the tape simple enough for one-handed operation.

A further object and/or advantage of the present invention is to make the cutting mechanism safe to use and handle.

Still further object and/or advantage of the present invention is to provide a device that will cleanly cut the tape without leaving a serrated edge on the cut.

Another object and/or advantage is to attain the present invention in a construction that is simple and economical to manufacture.

The present invention is an apparatus that is useful for taping along the edge of a surface to be painted that lies adjacent to another surface that is not to be painted contemporaneously without having to use additional tools to cut the tape. The invention resides in the unique configuration of a rigid frame, a tape roll holder, a tape measurer, and a tape cutting mechanism into a single tape application apparatus. The tape roll holder is rotatably connected to the platform by means of an axle that is substantially perpendicular to and offset from one side of the frame. The tape cutting mechanism comprises at least two blades and operates much like a pair of scissors whereby it cuts the tape between the two opposing blades. One blade is fixedly mounted to a structural element extending perpendicularly from the frame and the second blade is rotatably connected to the first blade. The frame further includes a tape measuring means which ensures that the length of the tape will match the length of the surface to be taped up to an inside corner.

Other objects and/or advantages of the present invention will become apparent from a reading of the Specification and claims.

### DRAWING FIGURES

FIG. 1 is a perspective view of a first embodiment of the present invention in a tape application position illustrating its use in taping a surface such as a baseboard, doorframe, or window frame.

FIG. 2 is another perspective view depicting the invention from the reverse side to more clearly show the tape and cutting means.

FIG. 3 is an enlarged partial side view of the invention showing the tape measuring and cutting means in more detail.

FIG. 4 is a partial front view showing the cutting means and illustrating the path of the upper cutting blade as it closes with the lower cutting blade to cut the tape.

FIG. 5 presents a perspective view of an alternative embodiment of the present invention depicting two housing portions.

FIG. 6 shows in a partial side view an alternative embodiment of the present invention having a non-rotating tape guide.

FIG. 7 is a partial sectional view of an alternative embodiment taken approximately along line 2-2 of FIG. 5 illustrating an alternative journaling means for the roll of tape.

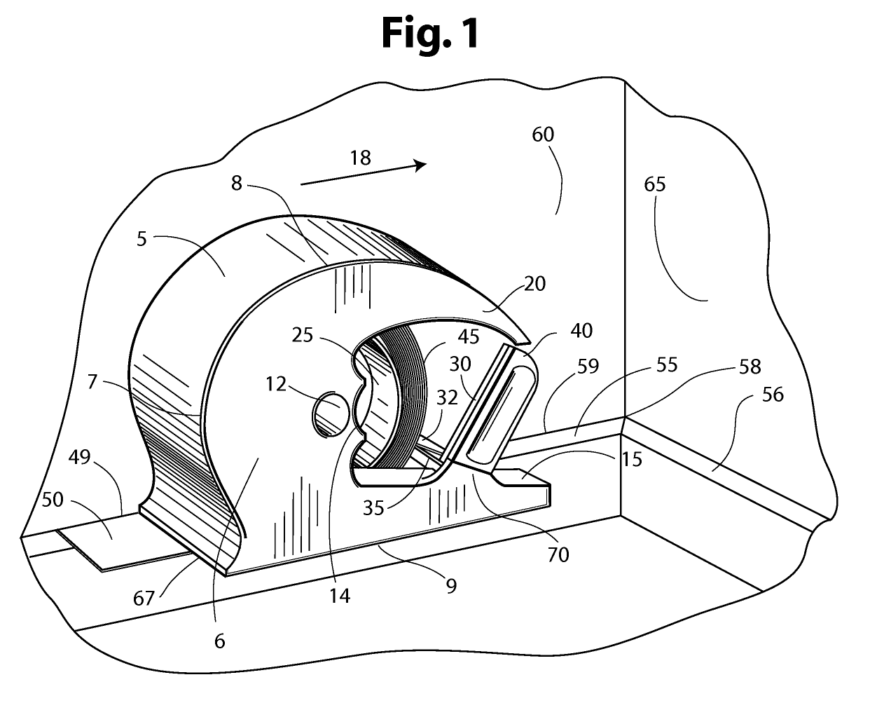

### DESCRIPTION—FIGS. 1 to 4—PREFERRED EMBODIMENT

FIGS. 1 through 4 illustrate a first embodiment of a taping apparatus of the present invention that can be used to manually apply a tape segment 42 along a surface to be protected 55, such as the top of a baseboard 55 or a ceiling 57, with an edge 49 of the tape aligning with an elongate edge 59 at the intersection of the surface to be protected 55 with a surface to be painted or otherwise treated 60 and, when coming to an inside corner 58, the apparatus can cut tape 32 off to the desired length fitting up to a third surface 65 lying substantially orthogonal to the surface to be protected 55 and the surface to be painted 60.

The taping apparatus of the present invention comprises a tape hub 25, a tape guide roller 41, upper and lower cutting blades 30 & 35, and a measuring stop 15 all connected to a frame 6. In the preferred embodiment, frame 6 is comprised of a substantially planar body having arcuate upper 8 and rear 7 edges with a peripheral wall 5 extending orthogonally therefrom, and a linear base edge 9 with a base wall 10 joined orthogonally thereto. Tape hub 25 is rotatably attached to frame 6 by a hub axle 12 and is centrally disposed on frame 6 between peripheral wall 5 and base wall 10. Tape hub 25 is annularly formed to support a tape roll 45 and is formed to be used with tape rolls in the common nominal widths of 1″, 1½″, or 2″. Tape guide roller 41 is cylindrically formed and disposed axially orthogonal to frame 6 and parallel to base wall 10. Guide roller 41 is rotatably connected to frame 6 by means of a roller axle 13 and disposed such that a point 43 at the bottom of roller 41 is coplanar with the bottom of base wall 10. Also centrally disposed on frame 6 is an aperture 14 formed to receive fingers or a thumb for gripping the apparatus.

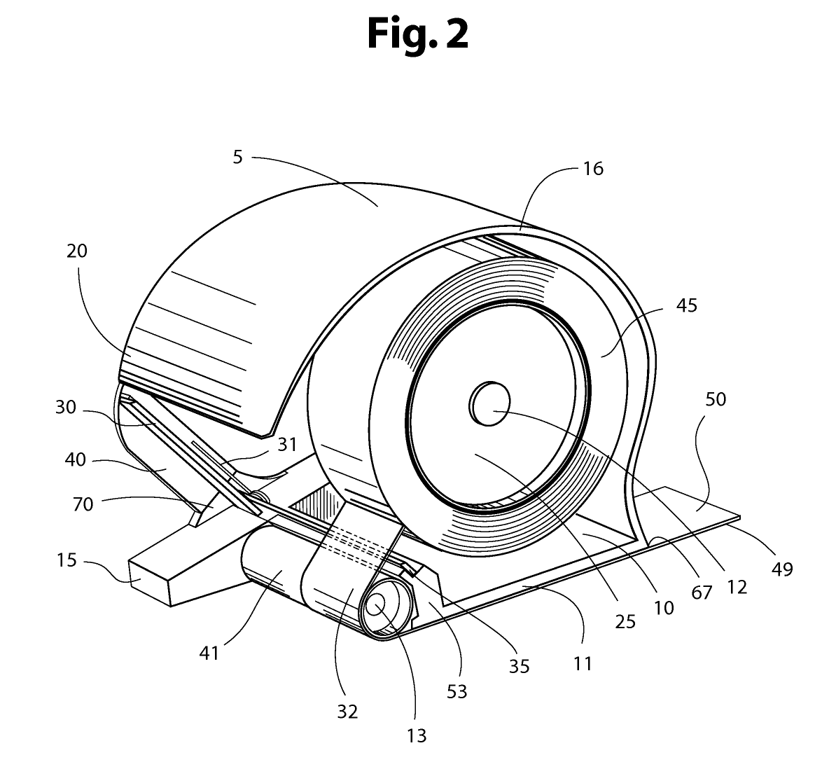

FIG. 2 more clearly shows tape hub 25 with tape roll 45 recessed between peripheral wall 5 and base wall 10. Base wall 10 supports a blade mounting structure 53 which is fixedly attached to lower cutting blade 35 the elongate edge of which is disposed substantially orthogonal to a guide edge 11 and parallel to base wall 10. An upper cutting blade 30 is rotatably linked to lower cutting blade 35 and is biased apart therefrom by a spring 31. A blade handle 40 is attached to upper blade 30 and is formed to accept a finger or thumb to manually depress blade 30 in a pivoting manner to close with lower blade 35. A blade stop 70 limits the spring-biased upward rotation of upper blade 30. The frame 6 further includes a forward section terminating in a blade guard 20 which is formed to prevent accidental contact with blades 30 & 35. Blade guard 20 is dimensioned to project forward enough to protect user from blades 30 and 35, but not to project farther forward than measuring stop 15, thus blade guard 20 will not interfere with the measuring stop 15 butting against the third surface 65.

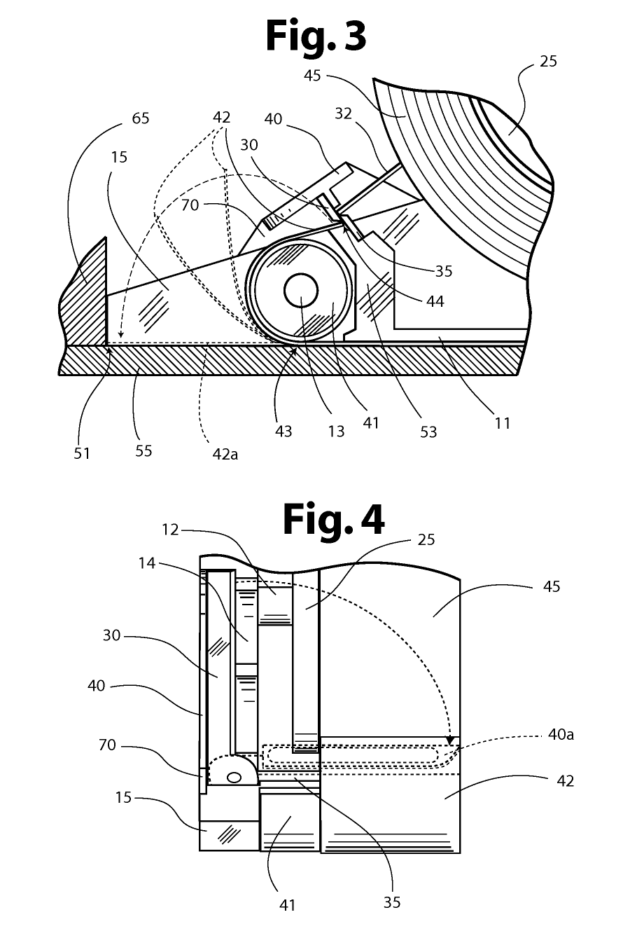

With reference to FIG. 3, the tape measuring structure is depicted in detail. Upper blade 30 is shown closed relative to lower blade 35 and cuts tape 32 resulting in a tape segment 42. The length of which, from a point 44 where tape 32 is severed to a point 43 under guide roller 41, is to be of substantially the same length as the measuring stop 15 as measured from point 43 to a point 51 at the forward end of measuring stop 15 where it butts into the surface 65.

The cutting structure is also described in detail in FIG. 3. Upper and lower blades 30 & 35 are angled at a predetermined angle away from the tape roll 45 such that they engage the tape 32 substantially orthogonally when upper blade 30 is depressed closed against lower blade 35. FIG. 3 also shows with broken lines the cut tape 42a adhered to the surface 55 and fitting up to surface 65. FIG. 4 clearly shows with broken lines the path of upper blade 30 as it closes with lower blade 35 and also shows with broken lines the blade handle 40a in a closed position with lower blade 35.

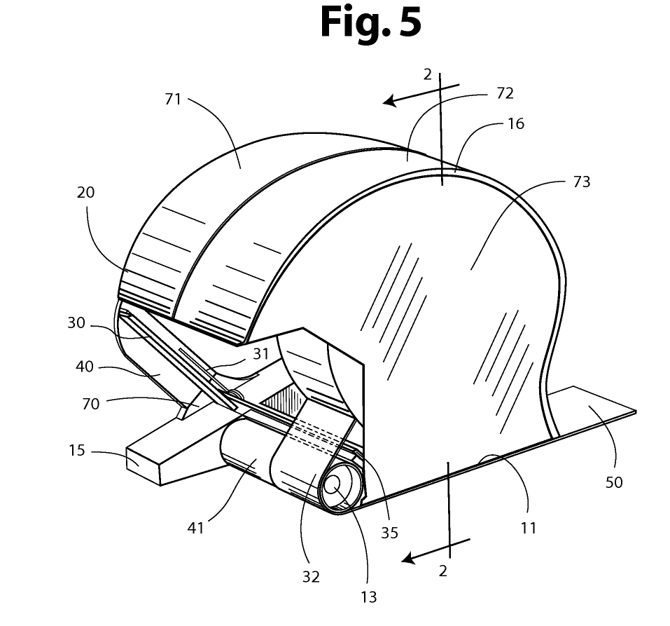

### FIGS. 5-7—Alternative Embodiments

FIG. 5 shows an alternative embodiment of the invention having a second frame section 72 covering tape roll 45 and hub 25 and is removably attached to a first frame section 71. To load the tape roll 45, the second frame section 72 is manually separated from the first frame section 71 and then reattached thereto after loading the tape roll 45. FIG. 5 shows the two frame sections 71 and 72 being relatively equal in size, but clearly they could be of any relative size. A side surface 73 of second frame section 72 is adapted to be slid along the surface to be painted 60.

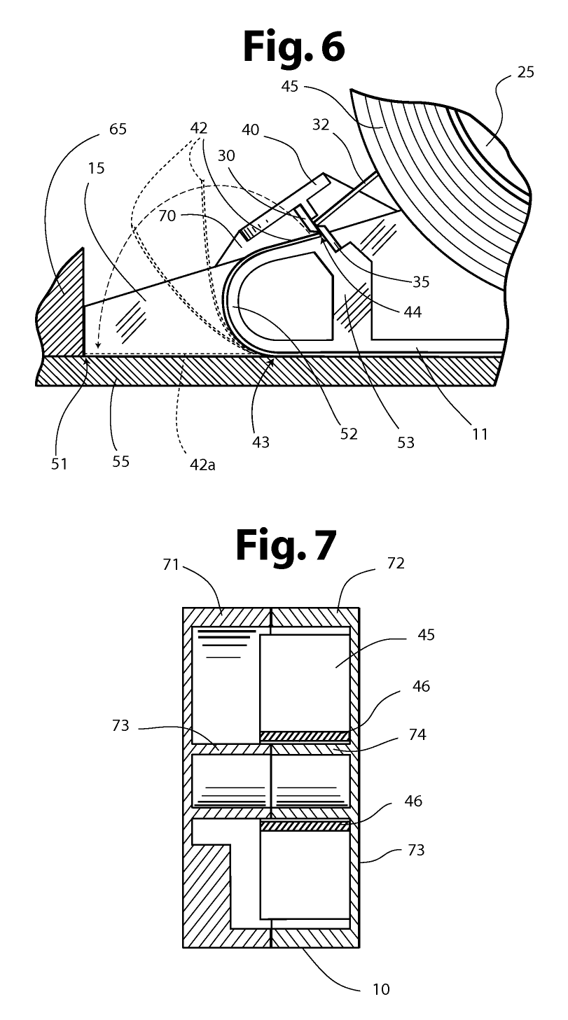

FIG. 6 shows an alternative tape guide means utilizing a tape guide 52 having a fixed arcuate surface rather than the rotating roller 41 of the preferred embodiment. The tape 32 slides around the tape guide 52 and is pressed to surface 55. In this alternative embodiment, the tape guide 52 can be formed as one piece with blade mounting structure 53 thereby reducing manufacturing costs.

Described in FIG. 7 is a sectional view taken along line 2-2 of FIG. 5 depicting an alternative journaling means for rotatably holding tape roll 45. Centrally disposed on the inside surface of each frame section 71 and 72 extends cylindrical projections 73 and 74 respectively which together rotatably hold tape roll 45 when frame sections 71 and 72 are joined. Projections 73 and 74 are dimensioned to be slightly smaller in diameter than the inside diameter of tape roll core 46 in order to allow free rotation of tape roll 45.

Advantages

From the description above, a number of advantages of my apparatus become evident:

(a) the apparatus reduces the amount of time required to apply tape to surface edges;

(b) the addition of a double-bladed scissor-like mechanism to the apparatus allows the user to cut tape square and to the desired length without leaving a serrated edge on the cut end;

(c) the cutting mechanism simultaneously holds and cuts the tape between the two blades allowing for accurate cuts;

(d) the clean, square cut allows a user to start tape flush in an inside corner and;

(e) the apparatus simplifies the painting process for all painters.

Operation—FIGS. 1 to 4

The manner of operating this apparatus is similar to that of other masking tape applicators in present use with the exception of the cutting mechanism which is more accurate and easier to use than previous art.

FIG. 1 depicts the taping apparatus of the invention in a position to apply tape to a molding such as a baseboard 55. Prior to applying tape using the apparatus, a user first press fits tape roll 45 onto tape hub 25 and aligns the edge of the tape roll 45 with the guide edge 11. This can be accomplished by simply pressing the partially mounted tape roll 45 against a flat surface like a wall 60 until guide edge 11 and wall edge 16 make contact therewith. Tape roll 45 frictionally engages with tape hub 25 and holds a position relative to guide edge 11 once alignment is performed.

FIG. 2 shows the tape roll 45 loaded onto the tape hub 25 in more detail. A free end of tape 50 will then be unwound from tape roll 45 with the adhesive side of tape 32 facing upward and traces a path over lower blade 35, redirects around tape guide roller 41, passes under base wall 10 and extends about 3 inches rearward of a base rear edge 67. The tape edge 49 is aligned with guide edge 11 and manually held in place while the applicator is placed on the wall 60 with guide edge 11 and wall edge 16 making contact therewith and base wall 10 contacting the surface to be protected 55 (see FIG. 1). The free end of tape 50 is manually pressed down and adhered to the surface to be protected 55. Also seen in FIG. 1, the apparatus is then manually slid along the wall 60 in direction 18 from left to right while the tape 32 is dispensed from tape roll 45 and pressed onto surface 55 by tape roller 41 and base wall 10.

Referring now to FIG. 3, the tape cutting operation is shown in detail. The taping apparatus is slid along surface to be protected 55 and upon coming to an inside corner 58, the measuring stop 15 butts into the adjacent third surface 65. The user then manually, by means of a finger or thumb on handle 40, depresses upper blade 30 closed with lower blade 35 and cuts tape 32 therebetween. Upon releasing handle 40, the spring 31 returns upper blade 30 back to the upright position away from lower blade 35. The apparatus is then removed from the wall 60 and the resulting cut tape 42 is the proper length to fit into the corner 58 and is then manually adhered to surface 55. Those skilled in the art will appreciate the ability to cut tape cleanly and accurately with one hand without the aid of additional cutting tools. This advantage is particularly useful when taping a ceiling while on a ladder as it is normally very difficult and dangerous to cut the tape with a separate tool when leaning over to one side of a ladder. When starting another tape application process, it is noteworthy that the beginning of the tape is cut cleanly and square from the previous tape application allowing a user to start applying the tape flush in an inside corner 58.

### CONCLUSION, RAMIFICATIONS AND SCOPE

Although the description above contains many specificities, these should not be construed as limiting the scope of the invention, but as merely providing illustrations of some of the presently preferred embodiments of this invention. It is specifically stated that the present invention is not limited to any overall dimensions. For example, said taping apparatus can be dimensioned to be used with any conventional and unconventional tape roll widths, and the apparatus can be adapted to be used with tape rolls of any inner and outer diameters. Furthermore, it is stated that the present invention is not limited to any material, so long as the material accomplishes the required task.

Thus the scope of the invention should be determined by the appended claims and their legal equivalents, rather than by the examples given.

What is claimed is:

1. A tape dispenser and applicator for manually applying tape to a surface and up to an edge of said surface comprising:
A frame rotatably housing a roll of tape, said frame having in a first plane a portion of a peripheral element adapted to be slid along a first surface to be taped, said frame also having in a second plane a side element that moves along a second surface that is adjacent and substantially orthogonal to said first surface, said frame further having a forward structure adapted to butt into a third surface that orthogonally intersects said first and second surfaces;
a tape guide structure having an arcuate peripheral surface around an axis and rotatably connected to said frame, said tape guide structure is axially disposed substantially parallel to said first plane and substantially orthogonal to said second plane;
a cutting apparatus having upper and lower cutting blades rotatably linked together for relative movement therebetween between open and closed positions, said upper and lower cutting blades each having an elongated cutting edge with said cutting edges disposed to pass each other in contiguous relationship along said elongated cutting edges as said upper and lower blades relatively move from open toward closed positions;
and a mounting means for said cutting apparatus to said frame whereby said lower blade is fixedly connected thereto and allowing a predetermined amount of pivotal movement of said upper blade, said mounting means also positioning said lower blade substantially parallel to said first plane and substantially orthogonal to said second plane.

2. The tape dispenser and applicator of claim 1, wherein said cutting apparatus contains a spring biasing means to hold said upper blade in an open position relative to said lower blade.

3. The tape dispenser and applicator of claim 2, wherein said cutting apparatus includes an upper blade stopper to limit the amount of spring-biased rotation of said upper blade relative to said lower blade.

4. The tape dispenser and applicator of claim 1, wherein said cutting apparatus includes a surface connected to said upper blade formed to receive a finger for manually depressing said upper blade from open to closed positions relative to said lower blade.

5. The dispenser and applicator of claim 1, wherein said forward structure is dimensioned to space said cutting apparatus a predetermined amount away from said third surface.

6. The dispenser and applicator of claim 4, wherein said cutting apparatus cuts tape to a length that will fit up to the intersection of said first, second and third surfaces.

7. The dispenser and applicator of claim 1, wherein said frame extends to substantially cover said upper and lower blades.

8. A tape dispenser and applicator for manually applying tape to a surface and up to an edge of said surface comprising:
A frame rotatably housing a roll of tape, said frame having in a first plane a portion of a peripheral element adapted to be slid along a first surface to be taped, said frame also having in a second plane a side element that moves along a second surface that is adjacent and substantially orthogonal to said first surface, said frame further having a forward structure adapted to butt into a third surface that orthogonally intersects said first and second surfaces;
a tape guide structure having an arcuate peripheral surface fixedly connected to said frame, said tape guide structure is axially disposed substantially parallel to said first plane and substantially orthogonal to said second plane;
a cutting apparatus having upper and lower cutting blades rotatably linked together for relative movement therebetween between open and closed positions, said upper and lower cutting blades each having an elongated cutting edge with said cutting edges disposed to pass each other in contiguous relationship along said elongated cutting edges as said upper and lower blades relatively move from open toward closed positions;
and a mounting means for said cutting apparatus to said frame whereby said lower blade is fixedly connected thereto and allowing a predetermined amount of pivotal movement of said upper blade, said mounting means also positioning said lower blade substantially parallel to said first plane and substantially orthogonal to said second plane.

9. The tape dispenser and applicator of claim 8, wherein said cutting apparatus contains a spring biasing means to hold said upper blade in an open position relative to said lower blade.

10. The tape dispenser and applicator of claim 9, wherein said cutting apparatus includes an upper blade stopper to limit the amount of spring-biased rotation of said upper blade relative to said lower blade.

11. The tape dispenser and applicator of claim 8, wherein said cutting apparatus includes a surface connected to said upper blade formed to receive a finger for manually depressing said upper blade from open to closed positions relative to said lower blade.

12. The dispenser and applicator of claim 8, wherein said forward structure is dimensioned to space said cutting apparatus a predetermined amount away from said third surface.

13. The dispenser and applicator of claim 12, wherein said cutting apparatus cuts tape to a length that will fit up to the intersection of said first, second, and third surfaces.

14. The dispenser and applicator of claim 8, wherein said frame extends to substantially cover said upper and lower blades.
